(19) United States
(12) Patent Application Publication
(10) Pub. No.: US 2024/0104487 A1
(43) Pub. Date: Mar. 28, 2024

(54) INTELLIGENT SHIPMENT ANALYSIS AND ROUTING

(71) Applicant: XPO Logistics, Inc., Greenwich, CT (US)

(72) Inventors: Matthew Carroll, Brighton, MI (US); Christopher Callahan, South Lyon, MI (US); Jason Silberkleit, Greenwich, CT (US)

(21) Appl. No.: 17/698,716

(22) Filed: Mar. 18, 2022

(51) Int. Cl. G06Q 10/08; G06N 20/20; G06Q 10/04

(52) U.S. Cl. CPC G06Q 10/0832; G06N 20/20; G06Q 10/047

(57) ABSTRACT

One example method includes receiving information for a shipment, the shipment comprising one or more pieces, the information comprising information about a destination; receiving, from a remote dimensioning device, dimension information, the dimension information providing a length, a width, and a height for each of the one or more pieces; transporting, using one or more first transport vehicles, the shipment to a first shipper facility; allocating, using a first trained machine learning (“ML”) model and the dimension information, each piece of the shipment to one or more second transport vehicles and loading each piece of the shipment according to the allocating, wherein the first trained ML model is trained based on length, width, and height dimension information for one or more pieces; transporting, using the one or more second transport vehicles, the shipment to a second shipper facility; allocating, using a second trained machine learning (“ML”) model and using the dimension information, each piece of the shipment to one or more third transport vehicles and loading each piece of the shipment according to the allocating, wherein the second trained ML model is trained based on at least two of the length, width, or height dimension information for the one or more pieces; and transporting, using the one or more third transport vehicles, the shipment from the third shipper facility to the destination.

### FIELD

The present application relates to intelligent shipment analysis and routing of packages in a shipping network.

### BACKGROUND

To transport items from a source to a destination, a shipper must be notified of the shipment of one or more items and dispatch a suitable vehicle to retrieve the shipment. After which, the shipment is moved into the shipper's transit network, where the shipper must identify one or more vehicles that can transport the shipment to another location within the transit network that is nearer the destination. Allocating shipments to vehicles within the network can be difficult because shipments from various senders have different sizes, shapes, and weights, and accurate information about the shipments is oftentimes unavailable, whether due to miscalculations by the sender or simply a lack of shipment information being provided.

Shipment information, when it is provided, includes weight or volume information, which the shipper can use to make an educated guess about the nature of the shipment, e.g., the number of items in the shipment, or the general size and shape of the shipment. However, once the shipment is received and the shipper attempts to allocate it to one or more transit vehicles, oddly sized or shaped items can create internal inefficiencies where a vehicle allocated for a shipment may be unsuitable because a different shipment has taken up unexpected space or because the shipment itself has irregular dimensions. And even if personnel within the shipper's transit network are able to determine more accurate dimension information, systems designed to handle shipments measured by weight or volume cannot accommodate more accurate dimension information.

### SUMMARY

Various examples are described for intelligent shipment analysis and routing. One example method includes receiving information for a shipment, the shipment comprising one or more pieces, the information comprising information about a destination; receiving, from a remote dimensioning device, dimension information, the dimension information providing a length, a width, and a height for each of the one or more pieces; transporting, using one or more first transport vehicles, the shipment to a first shipper facility; allocating, using a first trained machine learning (“ML”) model and the dimension information, each piece of the shipment to one or more second transport vehicles and loading each piece of the shipment according to the allocating, wherein the first trained ML model is trained based on length, width, and height dimension information for one or more pieces; transporting, using the one or more second transport vehicles, the shipment to a second shipper facility; allocating, using a second trained machine learning (“ML”) model and using the dimension information, each piece of the shipment to one or more third transport vehicles and loading each piece of the shipment according to the allocating, wherein the second trained ML model is trained based on at least two of the length, width, or height dimension information for the one or more pieces; and transporting, using the one or more third transport vehicles, the shipment from the third shipper facility to the destination

One example system includes a communications interface; a non-transitory computer-readable medium; and one or more processors communicatively coupled to the communications interface and the non-transitory computer-readable medium, the one or more processors configured to execute processor-executable instructions stored in the non-transitory computer-readable medium to receive information for a shipment, the shipment comprising one or more pieces, the information comprising information about a destination; receive, from a remote dimensioning device, dimension information, the dimension information providing a length, a width, and a height for each of the one or more pieces; allocating, using a first trained machine learning (“ML”) model and the dimension information, each piece of the shipment to one or more first transport vehicles, wherein the first trained ML model is trained based on length, width, and height dimension information for one or more pieces; and allocate, using a second trained machine learning (“ML”) model and using the dimension information, each piece of the shipment to one or more second transport vehicles, wherein the second trained ML model is trained based on at least two of the length, width, or height dimension information for the one or more pieces.

One example non-transitory computer-readable medium comprising processor-executable instructions configured to cause one or more processors to receive information for a shipment, the shipment comprising one or more pieces, the information comprising information about a destination; receive, from a remote dimensioning device, dimension information, the dimension information providing a length, a width, and a height for each of the one or more pieces; allocating, using a first trained machine learning (“ML”) model and the dimension information, each piece of the shipment to one or more first transport vehicles, wherein the first trained ML model is trained based on length, width, and height dimension information for one or more pieces; and allocate, using a second trained machine learning (“ML”) model and using the dimension information, each piece of the shipment to one or more second transport vehicles, wherein the second trained ML model is trained based on at least two of the length, width, or height dimension information for the one or more pieces.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example shipper networks for intelligent shipment analysis and routing;

FIG. 3 shows an example system for intelligent shipment analysis and routing;

FIG. 4 shows example interior storage volumes used by a shipper to transport shipments;

FIG. 5 shows an example method for intelligent shipment analysis and routing; and

FIG. 6 shows an example computing device suitable for use with systems and methods for intelligent shipment analysis and routing.

### DETAILED DESCRIPTION

Examples are described herein in the context of intelligent shipment analysis and routing. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Obtaining accurate dimension information from entities that send items (“shipping entities”) via a shipper can be challenging because a large volume of items requires significant effort to measure in three dimensions. In addition, shipping entities rarely have an incentive to accurately measure their shipments because it increases their costs, but the benefits generally accrue to the shipper. Shippers, on the other hand, are incentivized to obtain accurate shipment dimensions, but a shipping vehicle, such as a truck, typically only has one person in it, who must direct their efforts to loading the shipment items, handling paperwork, such as Bills of Lading, or providing updates to a dispatcher. Adding the burden to measure all of those items would significantly increase the time needed to receive a shipment from the shipping entity. Thus, shipping entities and shippers rely on rough estimates based on weight and volume. Furthermore, volumetric measurements may only be available based on approximations obtained from past shipments and the individual items in the shipment (or “pieces” of the shipment), e.g., a pallet. Such approximations necessarily involve a degree of error, leading to unused space within a shipping vehicle or to items being re-allocated to different vehicles on the fly, which can involve those items waiting in a cross-dock location, if no vehicles have available space.

To improve the efficiency in moving shipments from a shipping entity to the intended recipient, a shipper may implement a system that makes use of several machine-learning (“ML”) models that can ingest dimensional measurements for a shipment, i.e., length, width, and height, and individual pieces within the shipment. These dimensional measurements may be obtained from handheld devices that can quickly determine item dimensions based on stereoscopic images captured of the pieces in a shipment. The device can capture one or more images of the shipment and determine its dimensions, which can be associated with the shipment and transmitted to the shipper, either before the shipper's vehicle is dispatched to pick up the shipment, while the shipper's vehicle is at the shipping entity's location, or after the shipper's vehicle has arrived at a facility in the shipper's shipping network.

The dimension information can be ingested and stored by the shipper's shipment analysis and routing system, which can initially employ a ML model to learn types of shipments received from a particular shipment entity. This first ML model can then be used to predict likely dimensions of new shipments from a shipping entity before precise measurements are received.

After obtaining the dimensions for the pieces in the shipment, another ML model can receive the shipment dimension information, information about one or more other pending shipments, and one or more available vehicles assigned to transit to another shipper facility near the intended destination for the shipment. Based on this information, the ML model can allocate pieces of the shipment to the vehicle(s). In some cases, the ML model can assign individual pre-defined shipment locations within a specific vehicle to a specific piece within a shipment. Thus, the shipper can define individual item locations within its vehicles, e.g., semi-trailers, and allocate pieces to those specific locations. Further, in cases where a vehicle can accommodate multiple levels of pieces, rather than all pieces being loaded on the floor, the ML model can assign pieces to one of the levels and, in some cases, to specific pre-defined locations on a specific level. Thus, the ML model can provide precise loading instructions for each individual vehicle, thereby improving shipment density within the vehicle and reducing the amount of unused space. This can improve vehicle utilization as well as reduce overall shipping time within the shipper's network.

Once the shipment has arrived at a shipper facility where it will be transported directly to the intended recipient, a third ML model can allocate shipments to shipper vehicles. At this stage in the shipping process, the third ML model operates only on areal footprint for the pieces. The “last-mile” portion of the shipping journey may only load pieces onto the floor of the vehicle because recipients may lack the facilities, e.g., forklifts or loading docks, to offload stacked items. Thus, the third ML model uses the precise dimension information for the shipment pieces to determine areal loading for each piece of a shipment within one or more individual vehicles.

The cascaded architecture using different ML models trained to handle different aspects of the shipping process can significantly improve the efficiency and timeliness of moving shipments through a shipper's network from the shipping entity to the intended recipient. This can reduce the number of vehicles needed to move a particular number of shipments, thereby reducing miles driven, fuel consumption, and emissions, increase shipping speed, and reduce shipment delays.

While certain features of this illustrative example have been described, it is only given to introduce the reader to the general subject matter discussed herein and the disclosure is not limited to this example. The following sections describe various additional non-limiting examples and examples of intelligent shipment analysis and routing.

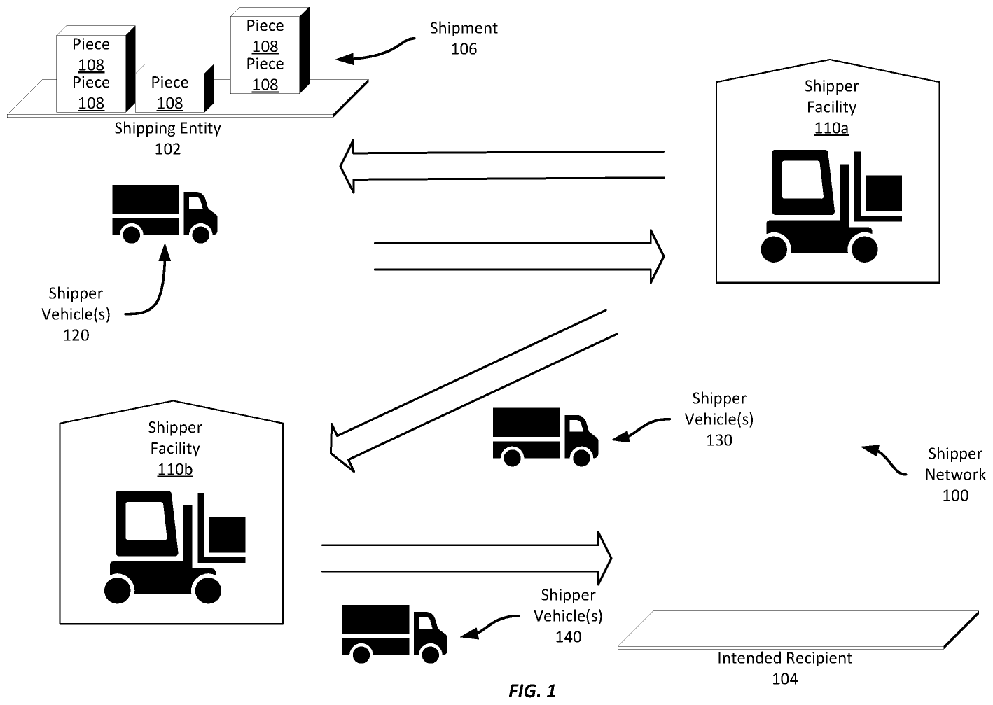

Referring now to FIG. 1, FIG. 1 shows an example of a shipper's network 100 and the flow of a shipment 106 through the shipper's network 100 from a shipping entity 102 to the intended recipient 104. A shipping entity 102 prepares a shipment 106 that includes one or more pieces 108 and notifies the shipper of the shipment 106.

After receiving information about the shipment 106, the shipper dispatches one or more vehicles 120 to the shipping entity 102 to pick up the shipment 106. The vehicle(s) 120 then proceed to a shipper facility 110a where the pieces 108 of the shipment 106 are offloaded and transferred to another vehicle (or vehicles) 130 to be transported to another shipper facility 110b that is nearer to the intended recipient's location. After the shipment 106 arrives at the shipper facility 110b, it is loaded onto one or more shipper vehicles 140 and transported to the intended recipient 104, where it is offloaded.

While this example involves only one internal shipment leg between shipper facility 110a and shipper facility 110b, some shipments may be transported between multiple shipper facilities as they are transported to the intended recipient 104.

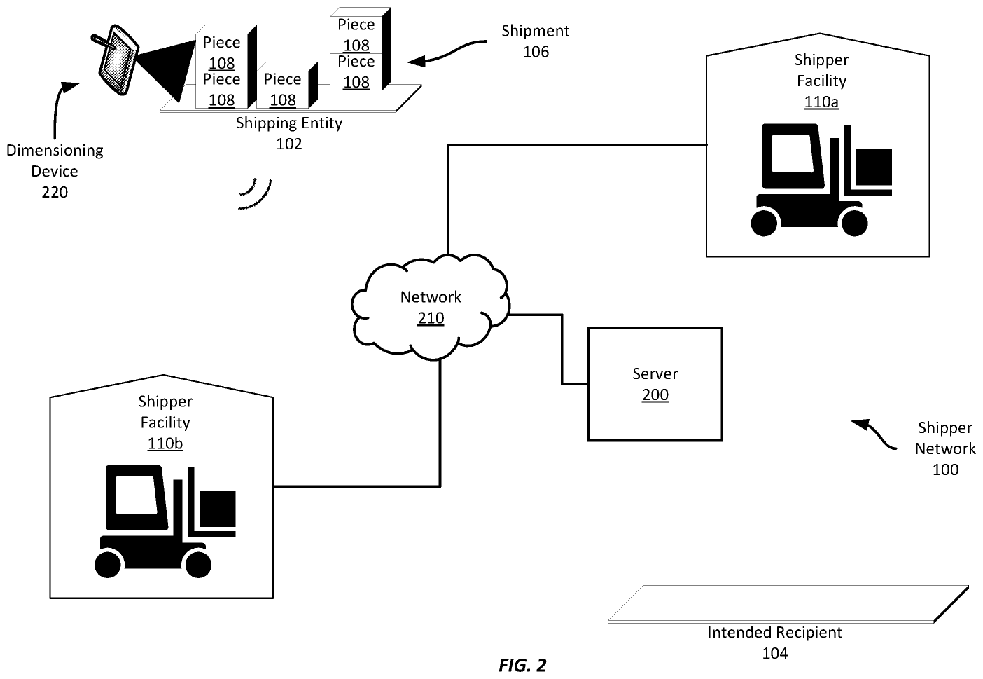

To coordinate this process, the shipper operates an intelligent shipment analysis and routing system according to this disclosure, examples of which will be discussed in more detail with respect to FIGS. 2-5.

FIG. 2 shows the shipper network 100 from FIG. 1, but also includes a server 200 that is in communication via network 210 with computing devices (not shown) located at the shipper facilities 110a-b. Any suitable network, or combination of networks, may be employed, including local area networks or the Internet. The server 200 executes intelligent shipment analysis and routing software, described in more detail below, to determine how to allocate shipments to shipper vehicles 120-140 as they are picked up, transported, and delivered. The server 200 in this example is located at a shipper facility, though it may be located in any suitable location, including at a cloud service provider.

In this example, the shipper network 100 also includes one or more dimensioning devices 220 that can be used to capture accurate dimensions of pieces 108 in a shipment 106. In this example, the dimensioning device 220 is a handheld electronic device that includes two cameras arranged to capture stereoscopic images. Some examples may also include a laser or ultrasonic rangefinder that can be used to determine distances between two points. For example, the dimensioning device 220 may include a RealSense™ depth camera from Intel® Corporation to enable the dimensioning device 220 to capture images of the pieces 108 in the shipment and determine their length, width, and height dimensions. In some examples, the dimensioning device 220 may employ a depth camera or a laser ranging device, such as Lidar to capture accurate dimension information.

After determining the dimensions of pieces 108 in the shipment 106, the dimensioning device 220 transmits the dimension information to the server 200 via the network 210. In this example, the dimensioning device 220 wirelessly connects to a local area network, such as via a WiFi connection, and transmits the dimension information to the server 200 via one or more networks 210; however, some examples may employ other types of communication networks, such as a cellular network. The server 200 receives the dimension information and associates it with the shipment information. It then executes its intelligent shipment analysis and routing software to allocate the shipment 106 to one or more vehicles based on the available vehicles and dimensions of shipments or pieces already allocated to (or loaded onto) the one or more vehicles. In some cases, it may allocate individual pieces 108 of the shipment to one or more vehicles, or even to pre-defined individual locations on one or more vehicles.

In this example, the dimensioning device 220 is used at the shipping entity 102, whether by personnel working for the shipping entity or by personnel working for the shipper. However, it should be appreciated that dimensioning of the shipment 106 or the individual pieces 108 using the dimensioning device 220 may occur at a shipper facility 110a-b after the shipment 106 has already been picked up by the shipper, or it may occur at multiple times during the course of shipping the shipment 106.

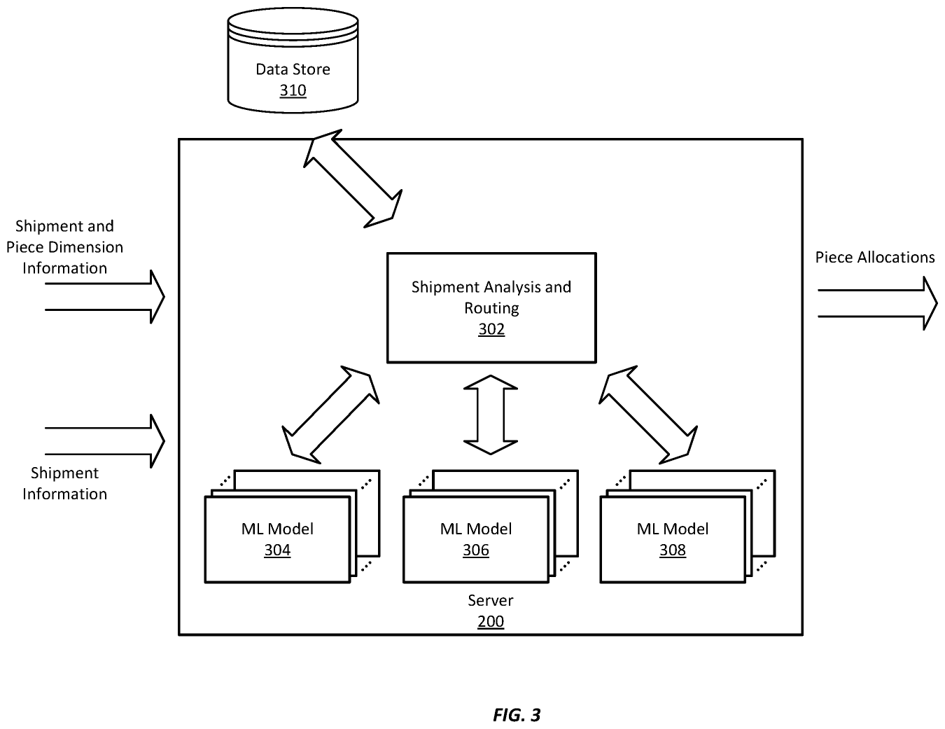

Referring now to FIG. 3, FIG. 3 shows an example server 200 for intelligent shipment analysis and routing. The server 200 in this example includes shipment analysis and routing software 302 (or “analysis software 302”), which receives shipment information and shipment and piece dimension information. The analysis software 302 uses ML models 304-308 to determine different aspects of shipping the shipment 106, which will be described in more detail below. The analysis software 302 also has access to data store 310, which may be a part of the server 200 or may be connected to the server 200, such as via one or more network connections. The data store 310 may be used to store shipment information, dimension information, as well as one or more of the ML models 304-308.

In this example, the analysis software 302 receives shipment information from the shipping entity 102, such as via network 210, and identifies a number of pieces 108 in the shipment 106. In general, shipment information may include any information regarding the shipment 106, such as the shipping entity 102 and the intended recipient 104. It may also include a shipment identifier and one or more piece identifiers, and may identify the number of pieces 108 in the shipment, a weight of one or more pieces 108 in the shipment, a volume of one or more pieces 108 in the shipment, or dimensional information for one or more pieces 108 in the shipment. The shipment information is generally received by the server 200 before the shipment 106 has been picked up, or even before a shipper vehicle has been dispatched to pick up the shipment.

In addition to the shipment information, the server 200 receives dimension information for one or more pieces in the shipment 106. As discussed above, the dimension information may be received with the shipment information; however, in this example, dimension information is received separately from the shipment information. For example, the dimension information may be received from a dimensioning device 220, while the shipment information may be generated at a different computing device. The dimension information includes the length, width, and height of each piece 108 within the shipment 106, or of the shipment 106 itself, and is associated with the corresponding shipment in the data store 310.

After receiving the shipment information and the dimension information, the analysis software 302 associates them together and stores them in the data store 310. In this example, the shipment information is received before the dimension information, so the analysis software 302 selects and employs an ML model 304 to determine estimated dimension information for the shipment. The ML model 304 is one of multiple ML models 304 that have been trained for different frequent shipping entities. Each ML model 304 is trained for particular shipping entity based on received shipping information and subsequently determined dimension information. Over time, if a particular shipping entity typically ships shipments that are composed of the same or similar number of pieces or consistently sized pieces, it can learn that shipping information refers to shipments of particular numbers or types of pieces. Thus, the shipper can learn the shipping habits of its customers.

Because shipping entities may ship more than one type of product as pieces in shipments, a shipping entity may have multiple associated ML models 304 corresponding to different types of shipments and pieces. Thus, when the analysis software 302 receives shipment information from a shipping entity, it can access the data store 310 to identify the corresponding ML models 304 for the shipping entity. The analysis software 302 can then use one or more of the ML models 304 to determine likely dimensions for the shipment, the pieces in the shipment, and the number of pieces in the shipment. This estimated information can be then used to perform subsequent functionality, such as with subsequent ML models 306, 308, without separately dimensioning the shipment 106 or its pieces 108 using a dimensioning device 220. However, in some examples, the dimensioning device 220 may be used to provide dimensional information for the shipment 106.

If dimensional information is provided by the dimensioning device 220, the analysis software 302 may instead employ the dimension information received from the dimensioning device 200 with subsequent ML models 306-308. It may further use the received dimension information to update ML model 304. For example, the received dimension information disagrees with the predicted dimension information from the ML model 304 by more than a pre-determined threshold, the analysis software 302 may update the ML model 304 using the received dimension information.

The ML model 304 may be any suitable ML model, such as a neural network, a deep convolutional neural network, a residual neural network, or a recurrent neural network, e.g., long short-term memory (“LSTM”) models or gated recurrent units (“GRUs”) models. The ML model 304 can also be any other suitable ML model, such as a three-dimensional CNN (“3DCNN”), a dynamic time warping (“DTW”) technique, a hidden Markov model (“HMM”), a support vector machine (“SVM”), etc., or combinations of one or more of such techniques—e.g., CNN-HMM or MCNN (Multi-Scale Convolutional Neural Network). Further, some examples may employ adversarial networks, such as generative adversarial networks (“GANs”), or may employ autoencoders (“AEs”) in conjunction with ML models, such as AEGANs or variational AEGANs (“VAEGANs”).

In some examples, the ML model 304 may include one or more mixed-integer programming (“MIP”) models operating under one or more constraints. In some examples, such constraints may include preventing splitting or reallocating previously allocated shipments or pieces, one or more available trailers or vehicles, etc.

In this example, the ML model 304 may be used by the shipper to determine what kind of shipper vehicle 120 to dispatch to the shipping entity. For example, a shipper may operate multiple different types of shipper vehicles 120, such as cargo vans, box trucks, and tractors with semi-trailers. Depending on the predicted dimensions for the shipment, a suitable shipper vehicle 120 may be determined, such as based on an expected areal size of the shipment 106 or one or more pieces 108 within the shipment 106. In this example, the shipper uses the predicted dimension information to determine a predicted areal size or footprint for the shipment 106. The analysis software 302 may then determine a correspondence between the shipment's footprint and capacities for one or more types of shipper vehicles 120. It may also identify one or more shipper vehicles 120 that may be allocated for other shipments and reduce the available capacity for such shipper vehicles 120 according to the other shipments allocated to the respective shipper vehicles 120.

For example, if the shipment footprint is predicted to be 50 square feet (“sq. ft.” or “sf”), and two box trucks are available, one with 35 available sq. ft. of capacity and the other with 60 available sf of capacity due to other shipments already being loaded on the vehicles, it may select the box truck with 60 sf available. Alternatively, the analysis software 302 may use the ML model 304 to determine that the shipment is predicted to include 5 pieces 108, each with a 10 sf footprint. It may then dispatch both box trucks to pick up a part of the shipment 106. This may fill one box truck, which may return to a shipper facility 110a, while the second may be partially filled and dispatched to another shipping entity to pick up another shipment.

In some examples, the analysis software 302 may transmit one or more messages to a shipper vehicle driver to capture dimension information for the shipment. The driver may then use a dimensioning device 220 to capture dimensions of the shipment 106 after they arrive at the shipping entity 102. The captured dimension information is then transmitted to the server 200 as discussed above with respect to FIG. 2. Alternatively, the analysis software 302 may transmit one or more messages to the shipper facility 110a to instruct personnel to capture dimension information after the shipment 106 arrives and is off-loaded from the shipper vehicle(s) 120. At that time, the personnel at the shipper facility 110a may use one or more dimensioning devices 220 to capture dimension information for the shipment 106 or its pieces 108.

The analysis software 302 uses another ML model 306 to allocate the shipment 106 or pieces 108 within the shipment to one or more shipper vehicles 130 to transport the shipment 106 from the shipper facility 110a to another shipper facility 110b, such as a shipper facility 110b nearer the intended recipient.

ML model 306 may be any suitable type of ML model, such as one of those discussed above. The ML model 306 receives dimension information for pieces of multiple shipments intended for a common destination, such as a shipper facility 110b, and receives information about one or more shipper vehicles 130 available for transit to the common destination. The ML model 306 has been trained to allocate pieces to available cargo capacity in the inputted shipper vehicles based on dimensions of the various pieces in the shipments, the destinations of various vehicles, and the shipments or pieces already allocated to those vehicles. For example, during training, the ML model 306 may be provided with input data for simulated (or actual) shipments and pieces as well as available transport vehicles. The output allocations may be compared to a pre-determined allocation and the ML model 306 may then be adjusted based on a different between the output allocation and the pre-determined allocation. In some examples, the ML model 306 has been trained to bias towards keeping pieces from a single shipment together in a single vehicle, even if a more efficient use of space may be obtained by splitting a shipment across multiple vehicles; however, such a bias may not be employed according to some examples. Further, because the shipper may continuously receive new shipments that need to be allocated, it may update or change allocations over time by iteratively performing the allocation analysis for shipments waiting to be loaded onto vehicles. Thus, an initial allocation of one shipment may be based on a prior allocation.

Further, if another shipment is later determined to be allocated to the same vehicle or vehicles, before the prior shipment has been loaded, in some examples the analysis software 302 may change the prior allocations. Or in some examples, it may not change existing allocations and may instead only allocate the new shipment based on the prior allocations and the information about the new shipment.

In some examples, the ML model 306 may receive pre-defined locations available on the one or more available shipper vehicles 130. For example, a shipping vehicle may be divided into discrete areas on the floor of the vehicle's cargo area or on one or more additional levels above the floor. The pre-defined locations may be determined by the ML model 306 in some examples; however, in some examples, the ML model 306 may receive pre-defined location information associated with one or more shipper vehicles 130 or one or more shipper vehicle types. For example, box trucks may have an associated set of pre-defined set of locations within the truck's box that may be allocated, irrespective of which box truck is available. However, in some examples, the ML model 306 may subdivide the box truck's box dynamically when allocating a shipment to the box truck.

The ML model 306 may output vehicle assignments for each shipment or each piece in a shipment, which may be provided to personnel located at the shipper facility 110a. For example, the vehicle assignments may be provided to handheld devices carried by personnel at the shipper facility 110a or to one or more display stations within the shipper facility 110a. Thus, personnel responsible for loading the shipment onto the shipper vehicles 130 will know where to load each shipment.

In addition to vehicle assignments, the ML model 306 may output pre-determined locations within the assigned vehicle(s) for a shipment 106. The pre-determined locations may be assigned to the shipment 106 as a whole, e.g., the shipment 106 may be assigned to locations 1-3 in a shipper vehicle 130, or the pre-determined locations may be assigned to one or more pieces 108 within the shipment 106. Predetermined locations may be assigned according to any suitable criteria, such as size and shape of the respective piece or other pieces assigned to the vehicle, the delivery sequence for shipments or pieces on a vehicle, etc. Thus, the personnel may be provided with specific locations within a vehicle to load a specific piece within the shipment, or, if the shipment includes multiple pieces of the same type, the specific locations may be assigned to a particular piece type.

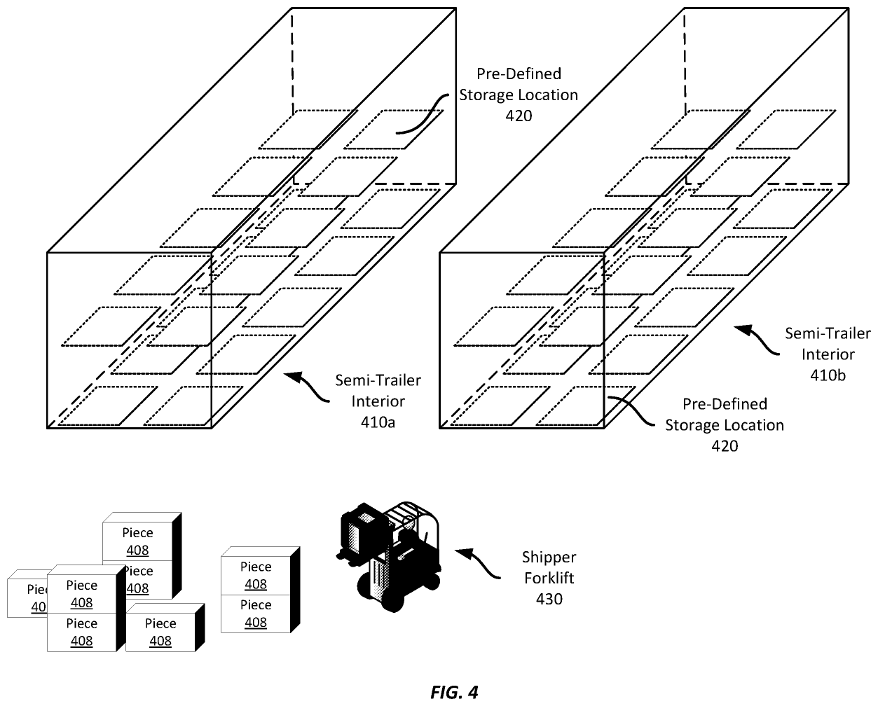

Referring now to FIG. 4, FIG. 4 shows two interior storage volumes 410a-b within semi-trailers used by a shipper to transport shipments. As shown in FIG. 4, each storage volume 410a-b has two levels to receive shipments or pieces 408 and ten pre-defined storage locations 420 on each level within the semi-trailer interior 410a-b. It should be noted that while pre-defined storage locations 420 are depicted in the figure, there may not be physical discrete storage locations defined within a vehicle, e.g., discrete shelves, bins, cabinets, etc. Instead, the pre-defined storage locations 420 may be regions within the trailer that may be demarcated by paint, tape, etc. or may not be demarcated at all and the shipper personnel may just attempt to place a shipment or piece at a location they estimate to be the assigned location within the vehicle.

After the analysis software 302 determines vehicle assignments, and pre-defined locations in some examples, for each shipment or each piece in a shipment, shipper personnel receives those assignments and loads shipments or pieces 408 onto the assigned vehicles. In examples where the allocations identify pre-defined storage locations 420, shipper personnel may load specific pieces or shipments into specific pre-defined storage locations 420 within the corresponding vehicle.

Referring again to FIG. 3, after assigning shipments or pieces to vehicles 130 or even specific locations within a vehicle, the shipment is loaded along with other shipments or pieces, the vehicle(s) 130 transport the shipments to the next shipper facility 110b. If the next shipper facility 110b represents the last shipper facility 110 before delivery to the intended recipient 104, then the analysis software 302 employs ML model 308. Otherwise, the analysis software 302 may use ML model 306 again to determine one or more vehicles to assign to transport arriving shipments or pieces to subsequent shipper facilities.

It should be noted that there may be multiple ML models 306 used to allocate shipments or pieces to individual vehicles. For example, different ML models 306 may be used for different vehicle or trailer types. Alternatively, different shipper facilities may have different capabilities, so different ML models 306 may be trained to accommodate the different capabilities available at different facilities. For example, some shipper facilities may lack loading bays to accommodate stacking shipments or pieces within a vehicle, some shipper facilities may only accommodate certain types of vehicles, etc.

As mentioned above, to allocate shipments or pieces to vehicles for the final leg for delivery to intended recipients, the analysis software 302 may use a further ML model 308 to allocate shipments and pieces to individual shipper vehicles. The ML model 308 may be trained to allocate shipments or pieces to a single level in a shipper vehicle, which may accommodate the fact that intended recipients may lack facilities to offload stacked pieces. Thus, the ML model 308 may be provided the precise dimension information for a shipment 106 or its pieces 108, but may allocate them based on a two-dimensional area, rather than a three-dimensional volume. This may allow the shipper facility 110b to more efficiently load a shipper vehicle for final delivery. In addition, the ML model 308 may be biased towards keeping all pieces 108 within a shipment 106 together on the same shipper vehicle 140 to avoid multiple shipper vehicles 140 travelling to the same intended recipient 104 for a single shipment. Such a bias may be more pronounced than in ML models 306 employed to allocate shipments and pieces for intra-shipper-network transport. However, in some examples, the analysis software may employ length, width, and height to allocate the shipment 106 or pieces 108 to one or more vehicles. Further, in some examples, such as where the intended recipient has suitable ability to offload stacked pieces, the ML model 308 may allocate pieces to multiple levels within the shipper vehicle.

The analysis software 302 may then output shipment and vehicle allocations to shipper personnel at the shipper facility 110b. The shipper personnel can then load the shipper vehicles 140 accordingly and dispatch them to deliver the shipment 106 to the intended recipient 104.

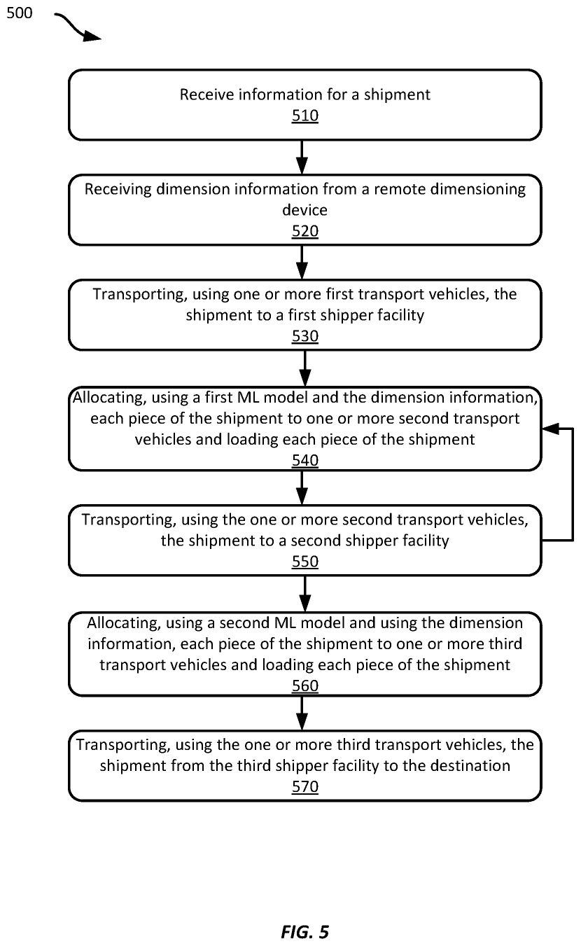

Referring now to FIG. 5, FIG. 5 shows an example method 500 for intelligent shipment analysis and routing. The example method 500 will be discussed with respect to the shipper network shown in FIGS. 1-2 and the server shown in FIG. 3; however, any suitable systems according to this disclosure may be employed.

At block 510, the server 200 receives information for a shipment 106 that includes one or more pieces 108. In this example, the information includes information about a destination for the shipment 106. In some examples the received information may include information about the shipment 106, such as a weight or volume, or it may include the one or more pieces 108. For example, the information may identify a number of pieces in the shipment, volumetric information about one or more of the pieces, dimensions of one or more of the pieces, weight information about one or more of the pieces, a destination address, an identity of an intended recipient for the shipment, etc.

At block 520, the server 200 receives dimension information from a remote dimensioning device 220 that includes a length, a width, and a height for each of the one or more pieces. In this example, the dimensioning device 220 is a handheld device that includes a stereoscopic camera as well as an infrared laser and infrared camera to allow the handheld device to capture images of the pieces in a shipment and determine the lengths, widths, and heights of those pieces. It then transmits the measured dimension information via one or more communications networks 210 to the server 200. In some examples, the dimensioning device 220 may be operated by the shipping entity 102, by personnel working for the shipper, or from a third party.

In some examples, the shipper may also use the analysis software 302 to determine predicted dimensions for the shipment 106 or for one or more of the pieces 108 within the shipment 106. For example, as discussed above with respect to FIG. 3, the shipper may train one or more ML models 304 associated with shipping entities 102 based on measured dimensions of shipments shipped for the shipping entity 102 by the shipper. In some examples, it may also train the ML model(s) 304 using information about the intended recipient 104. For example, a shipping entity 102 may frequently ship shipments including the same pieces to the same intended recipient 104. In some examples, the shipping entity 102 may even ship the same number of pieces 108 in shipments 106 to the intended recipient 104. Thus, when information for a new shipment is received, the shipper can execute analysis software 302, which uses ML model(s) 304, to predict the number of pieces within the shipment or the length, width, and height dimensions of the shipment or pieces within the shipment 106. In some examples, one or more of the ML models 304 may be trained to predict a number of pieces 108 in a shipment 106 if the received information about the shipment does not identify a number of pieces in the shipment.

At block 530, the shipper transports the shipment from the shipping entity 102 to a shipper facility 110a, generally as discussed above with respect to FIGS. 1-2.

At block 540, the server 200 executes analysis software 302 to allocate each piece 108 of the shipment 106 to one or more shipper vehicles 130. As discussed above with respect to FIG. 3, the analysis software 302 obtains the dimension information for the pieces 108, such as from the data store 310, and information about one or more available vehicles to transport the pieces 108 to a next destination, such as within the shipper network 100. The analysis software 302 then uses one (or more) of the ML models 306 to allocate the pieces 108 in the shipment 106 to one or more of the shipper vehicles 130. In some examples, the analysis software 302 may allocate pieces 108 or the shipment 106 to specific pre-defined locations 420 within a particular vehicle, as discussed above. For example, the ML model 306 may employ a bin-packing algorithm to determine potential piece allocations to trailers and use the outputs of the algorithm to generate one or more potential allocations. The allocations may be used in conjunction with other constraints to determine a final allocation of pieces to trailers.

In this example, the ML model includes one or more MIP models that operate using certain constraints in addition to dimension information for pieces. For example, these constraints may include costs of various potential allocation scenarios, such as based on costs to load or unload pieces, transit costs based on different length routes, and destinations for different trailers. In addition, constraints may include whether one or more pieces will be unloaded before other pieces allocated to the trailer. For example, if multiple pieces are allocated to a trailer, pieces allocated near the front of the trailer may be more difficult to unload first than if they had been loaded in the rear of the trailer. Thus, for pieces to be offloaded at a first stop, the MIP model may consider the added cost of allocating those pieces nearer the front of the trailer, which may involve unloading and reloading pieces that impede access to the pieces at the front of the truck. Similarly, piece weights may affect whether the piece should be loaded on the ground or on top of another piece. Additional constraints may include times of arrival of trailers carrying pieces to be allocated to a trailer. For example, pieces arriving on a first trailer may be allocated to a portion of the trailer in front of pieces arriving on a second trailer, even though the second trailer may be ready for unloading before the first trailer. Such constraints may ensure pieces are loaded in a more optimal order, despite some pieces being available for loading before others. Thus, such information may be employed in conjunction with the output of a bin-packing technique to allocate pieces to one or more shipper vehicles 130.

After allocating the pieces 108 to the one or more shipper vehicles 130, the allocation is provided to one or more shipper personnel, such as by displaying the allocation on one or more display screens or by transmitting the allocations to one or more remote devices, which may be carried by shipper personnel, installed on equipment at the shipper facility 110a (e.g., one or more forklifts), or printed out on paper. The shipper personnel then load the one or more transport vehicles according to the allocations. It should be appreciated that, during the loading process, the one or more shipping personnel may make adjustments to the allocation to more efficiently load pieces 108 onto the shipper vehicles or based on other events that may occur during the loading process. In some examples, if an allocation was inefficient, the actual loaded configuration of the pieces 108 onto the one or more shipper vehicles may be used to update the ML model 306 based on the provided allocation.

At block 550, the shipper transports the pieces 108 to another shipper facility 110b, generally as described above with respect to FIGS. 1-2. It should be appreciated that a shipment 106, or pieces within a shipment 108, may transit through more or less than two shipper facilities during the course of being shipped from the shipping entity 102 to the intended recipient 204. If the shipment, or pieces in the shipment, are transported to still further shipper facilities after arriving at shipper facility 110b, the method 500 may return to block 540 to perform another allocation of pieces 108 to shipper vehicles. Otherwise, the shipment arrives at the last shipper facility 110b before being sent out for delivery to the intended recipient 104 and the method 500 proceeds to block 560.

At block 560, the analysis software 302 allocates each piece of the shipment to one or more shipper vehicles 140 using one or more ML models 308, generally as described above with respect to FIG. 3. The allocations may be provided to shipper personnel generally as described above with respect to block 540. Similarly, when loading the pieces 108 onto the shipper vehicles 140, the personnel may adjust the allocations and, in some cases, one or more of the ML models 308 may be updated based on the actual allocation used by the personnel and the allocation output by the ML model(s) 308.

At block 570, the shipment is transported from the shipper facility 110b to the intended recipient 104.

While the method 500 has been discussed with respect to a particular ordering of the blocks, it should be appreciated that the blocks may be performed according to any suitable ordering. For example, block 530 may occur before block 520 in some examples. In other words, a shipment 106 may be transported from the shipping entity 102 to a shipper facility 110a, where the shipment 106 or its pieces 108 may be dimensioned. Similarly, the allocations performed at blocks 540 and 560 may be performed before the shipment is received at a shipper facility 110a-b, such as based on expected vehicles to be available at a subsequent shipper facility 110a-b. Thus, in some examples, the analysis software 302 may perform all allocations at blocks 540 and 560 once the dimension information is received, even if such dimension information is received before the shipment has been picked up from the shipping entity 102. Further, as discussed above, the analysis software 302 may iteratively allocate shipments or pieces within a particular shipper facility 110a-b as new shipments are received for allocation or based on shipments that are loaded onto one or more of the shipper vehicles 130.

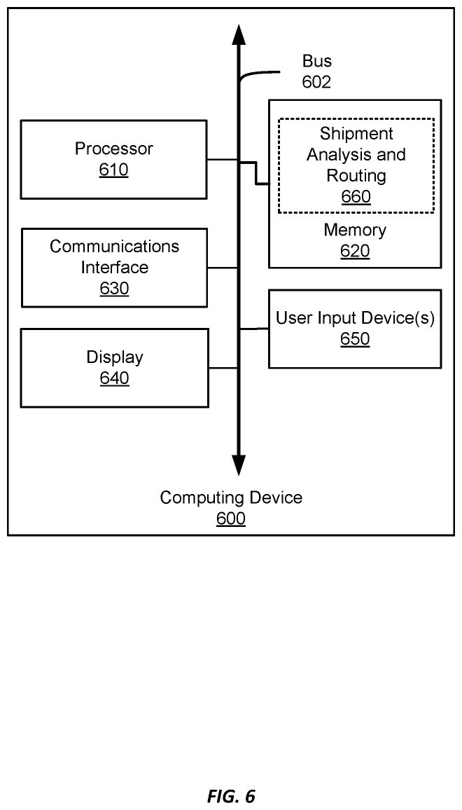

Referring now to FIG. 6, FIG. 6 shows an example computing device 600 suitable for use in example systems or methods for participant interactions during a virtual expo according to this disclosure. The example computing device 600 includes a processor 610 which is in communication with the memory 620 and other components of the computing device 600 using one or more communications buses 602. The processor 610 is configured to execute processor-executable instructions stored in the memory 620 to perform one or more methods for intelligent shipment analysis and routing according to different examples, such as part or all of the example method 500 described above with respect to FIG. 5. The computing device 600, in this example, also includes one or more user input devices 650, such as a keyboard, mouse, touchscreen, microphone, etc., to accept user input. The computing device 600 also includes a display 640 to provide visual output to a user.

In addition, the computing device 600 includes a shipment analysis and routing application 660 to allocate shipments or pieces to shipper vehicles for transit from the shipping entity 102 to a shipper facility 110a, within the shipper network 100, or from the shipper network 100 to an intended recipient 104.

The computing device 600 also includes a communications interface 640. In some examples, the communications interface 630 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving information for a shipment, the shipment comprising one or more pieces, the information comprising information about a destination;
receiving, from a remote dimensioning device, dimension information, the dimension information providing a length, a width, and a height for each of the one or more pieces;
transporting, using one or more first transport vehicles, the shipment to a first shipper facility;
allocating, using a first trained machine learning (“ML”) model and the dimension information, each piece of the shipment to one or more second transport vehicles and loading each piece of the shipment according to the allocating, wherein the first trained ML model is trained based on length, width, and height dimension information for one or more pieces;
transporting, using the one or more second transport vehicles, the shipment to a second shipper facility;
allocating, using a second trained machine learning (“ML”) model and using the dimension information, each piece of the shipment to one or more third transport vehicles and loading each piece of the shipment according to the allocating, wherein the second trained ML model is trained based on at least two of the length, width, or height dimension information for the one or more pieces; and
transporting, using the one or more third transport vehicles, the shipment from the third shipper facility to the destination.

2. The method of claim 1, further comprising determining a position on the second transport vehicle based on the dimension information.

3. The method of claim 2, wherein the determining the position comprises selecting a location from a set of predetermined locations for the respective second transport vehicle.

4. The method of claim 2, wherein determining the position comprises determining a vertical level within the second transport vehicle.

5. The method of claim 1, further comprising updating at least one of the second or third trained ML models based on the dimension information.

6. The method of claim 1, further comprising determining a position on the third transport vehicle based on the dimension information.

7. The method of claim 1, further comprising predicting, using a third ML model, the dimension information based on the information for the shipment.

8. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
receive information for a shipment, the shipment comprising one or more pieces, the information comprising information about a destination;
receive, from a remote dimensioning device, dimension information, the dimension information providing a length, a width, and a height for each of the one or more pieces;
allocating, using a first trained machine learning (“ML”) model and the dimension information, each piece of the shipment to one or more first transport vehicles, wherein the first trained ML model is trained based on length, width, and height dimension information for one or more pieces; and
allocate, using a second trained machine learning (“ML”) model and using the dimension information, each piece of the shipment to one or more second transport vehicles, wherein the second trained ML model is trained based on at least two of the length, width, or height dimension information for the one or more pieces.

9. The system of claim 8, wherein the one or more processors are configured to execute further processor-executable instructions stored in the non-transitory computer-readable medium to determine a position on the first transport vehicle based on the dimension information.

10. The system of claim 9, wherein the one or more processors are configured to execute further processor-executable instructions stored in the non-transitory computer-readable medium to select a location from a set of predetermined locations for the respective first transport vehicle.

11. The system of claim 9, wherein the one or more processors are configured to execute further processor-executable instructions stored in the non-transitory computer-readable medium to determine a vertical level within the first transport vehicle.

12. The system of claim 8, wherein the one or more processors are configured to execute further processor-executable instructions stored in the non-transitory computer-readable medium to update at least one of the first or second trained ML models based on the dimension information.

13. The system of claim 8, wherein the one or more processors are configured to execute further processor-executable instructions stored in the non-transitory computer-readable medium to determine a position on the second transport vehicle based on the dimension information.

14. The system of claim 8, wherein the one or more processors are configured to execute further processor-executable instructions stored in the non-transitory computer-readable medium to predict, using a third ML model, the dimension information based on the information for the shipment.

15. A non-transitory computer-readable medium comprising processor-executable instructions configured to cause one or more processors to:
receive information for a shipment, the shipment comprising one or more pieces, the information comprising information about a destination;
receive, from a remote dimensioning device, dimension information, the dimension information providing a length, a width, and a height for each of the one or more pieces;
allocating, using a first trained machine learning (“ML”) model and the dimension information, each piece of the shipment to one or more first transport vehicles, wherein the first trained ML model is trained based on length, width, and height dimension information for one or more pieces; and
allocate, using a second trained machine learning (“ML”) model and using the dimension information, each piece of the shipment to one or more second transport vehicles, wherein the second trained ML model is trained based on at least two of the length, width, or height dimension information for the one or more pieces.

16. The non-transitory computer-readable medium of claim 15, wherein the one or more processors are configured to execute further processor-executable instructions stored in the non-transitory computer-readable medium to determine a position on the second transport vehicle based on the dimension information.

17. The non-transitory computer-readable medium of claim 16, wherein the one or more processors are configured to execute further processor-executable instructions stored in the non-transitory computer-readable medium to select a location from a set of predetermined locations for the respective second transport vehicle.

18. The non-transitory computer-readable medium of claim 16, wherein the one or more processors are configured to execute further processor-executable instructions stored in the non-transitory computer-readable medium to determine a vertical level within the second transport vehicle.

19. The non-transitory computer-readable medium of claim 15, wherein the one or more processors are configured to execute further processor-executable instructions stored in the non-transitory computer-readable medium to update at least one of the second or third trained ML models based on the dimension information.

20. The non-transitory computer-readable medium of claim 15, wherein the one or more processors are configured to execute further processor-executable instructions stored in the non-transitory computer-readable medium to determine a position on the second transport vehicle based on the dimension information.

21. The non-transitory computer-readable medium of claim 15, wherein the one or more processors are configured to execute further processor-executable instructions stored in the non-transitory computer-readable medium to predicted, using a third ML model, the dimension information based on the information for the shipment.
